(19) United States
(12) Patent Application Publication
(10) Pub. No.: US 2007/0283622 A1
(43) Pub. Date: Dec. 13, 2007

(54) Method for hydroponic plant culture and container for same

(76) Inventor: Kenji Matsumura, Komatsushima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/812,014

(22) Filed: Jun. 14, 2007

(30) Foreign Application Priority Data
Nov. 17, 2005 (JP) 2005-332387

(51) Int. Cl. A01G 31/00

(52) U.S. Cl. 47/59 R

(57) ABSTRACT

In an embodiment of the method for hydroponic plant culture of the present invention, a hydroponic plant culture container is used which comprises an external container that holds water, and an internal container that is held inside the external container, is placed on and supported by the upper edge portion of the external container, and is filled with a growing medium with seeds sown on the upper surface side thereof These containers both are formed from a transparent or semitransparent synthetic resin. The internal container is a funnel-shaped container including a cup-shaped portion and a cylindrical portion extending downward from a central part of the bottom of this cup-shaped portion. The internal container is filled with a growing medium in a state in which a lower end of the cylindrical portion of the internal container is substantially in contact with a bottom face of the external container with a gap interposed therebetween, after which seeds are sown on the surface side of the growing medium, water is supplied through a watering port formed on one side of the cup-shaped portion of the internal container, so that water is supplied into the external container through a gap at the lower end of the cylindrical portion, and the water that has been supplied to and held in the external container is used to water the seeds sown in the internal container through the gap.

### TECHNICAL FIELD

This invention relates to a method for hydroponic plant culture and a container for hydroponic plant culture, primarily for the hydroponic culture of vegetables or of grass eaten by cats and dogs.

### BACKGROUND ART

With methods known and implemented in the past for hydroponically cultivating grass for dogs and cats, or sprout vegetables in the home, usually a container was filled with soil composed of a mixture of peat moss, vermiculite, and pearlite, for example, seeds were sown and covered with soil, and the seeds were watered from above, or a container was lined with a polyurethane mat or paper, seeds were sown over this and watered, and the plants were hydroponically cultivated in this way.

However, since these methods involved watering from the top part of the growing medium, water pressure caused the seeds to be exposed to the air or to clump together, resulting in uneven germination. Also, if the seeds come into contact with the air, they may develop mold because they are wet, and if they are over-watered, it can lead to seed rot, withering, wilting, molding, or root rot. On the other hand, if the grower forgets to water or does not water enough, this can also lead to wilting and withering. Accordingly, it is desirable to increase the watering frequency while using less water each time, and to water when the surface of the growing medium becomes dry, and to this end a method has been proposed in which a double structure comprising an external container and an internal container is used, water is put into the external container, growing medium and seeds are put into the internal container, and hydroponic culture is performed by a water collection system. (See, for example, JP H8-289682A and JP2001-211751A.)

However, even with the above hydroponic culture, the watering is still performed at the surface of the growing medium, and when the water inside the external container is constantly supplied to the growing medium tank, even if there is no over-watering, it is difficult to ascertain the proper watering time, and watering also takes a long time. So far, watering seeds from the bottom of the growing medium, which is more reliable method to carry out appropriate watering, has not been employed at all.

### SUMMARY OF THE INVENTION

In light of the above situation, it is an object of the present invention to provide a method for hydroponic plant culture and a container for hydroponic plant culture with which plants eaten by dogs and cats and other plants can be grown without any seed rot, withering, wilting, molding, or root rot, and with less frequent watering.

To achieve the stated object, the method for hydroponic plant culture of the present invention is conducted by using a hydroponic plant culture container comprising an external container that holds water, and an internal container that is held inside the external container, is placed on and supported by the upper edge portion of the external container, and is filled with a growing medium with seeds sown on the upper surface side thereof, wherein these containers both are formed from a transparent or semitransparent synthetic resin, and the internal container is a funnel-shaped container including a cup-shaped portion and a cylindrical portion extending downward from a central part of the bottom of the cup-shaped portion. With the method for hydroponic plant culture of the present invention, the internal container is filled with a growing medium in a state in which the lower end of the cylindrical portion of the internal container is substantially in contact with the bottom face of the external container with a gap interposed therebetween, after which seeds are sown on the surface side of the growing medium, water is supplied through a watering port formed on one side of the cup-shaped portion of the internal container, so that water is supplied into the external container through a gap at the lower end of the cylindrical portion, and further the water that has been supplied to and held in the external container is used to water the seeds sown in the internal container through the gap.

Preferably, in the method for hydroponic plant culture of the present invention with the above constitution, the upper limit to the water level inside the external container is at least 2.4 cm away from the location of the seeds sown in the internal container.

Also, preferably, with the method for hydroponic plant culture of the present invention, the above-mentioned gap is sized to be small enough that the growing medium will not flow out from the internal container, but large enough that the roots that grow out can extend from the internal container into the external container.

The hydroponic plant culture container of the present invention is a preferable device for use in the method for hydroponic plant culture of the present invention, comprising an external container that holds water, and an internal container that is held inside the external container, is placed on and supported by the upper edge portion of the external container, and is filled with a growing medium with seeds sown on the upper surface side thereof. These containers are both formed from a transparent or semitransparent synthetic resin, the internal container is a funnel-shaped container including a cup-shaped portion and a cylindrical portion extending downward from the central part of the bottom of this cup-shaped portion. A convex portion that mates with an opening in the lower end of the cylindrical portion is formed in a central part of the bottom face of the external container, a plurality of slanted grooves extending radially toward the bottom face are formed in this convex portion, and a watering port is provided on one side of the upper edge of the cup-shaped portion.

With the hydroponic plant culture container of the present invention, water that has come through the watering port is supplied to the external container through the internal container and through the slanted grooves, whereas the water that has been supplied to and held in the external container is supplied to the growing medium in the internal container through the slanted grooves, and the roots of the plants growing in the medium are able to spread out into the external container through the opening at the lower end of the cylindrical portion.

Thus, with the hydroponic plant culture container of the present invention, the slanted grooves are preferably sized to be small enough that the growing medium will not flow out from the internal container, but large enough that the roots that grow out can extend from the internal container into the external container.

The present invention described above is constituted such that the seeds are watered from the bottom of the growing medium, with water held in the external container through the watering port on one side of the cup-shaped portion of the internal container, rather than watering from the top surface of the growing medium, and therefore there is no germination unevenness caused by exposure or clumping of the seeds due to water pressure, nor is there any molding. Also, the growing medium can be one with high water absorptivity and that is soft and lightweight, and furthermore, if the gap of the slanted grooves, etc., is set properly, watering will not take too long. Furthermore, the growing medium is prevented from leaking into the external container, and if the roots should fill up the internal container in the pivotal stage of growth, this can lead to poor growth or a decrease in absorptivity, but these problems can be prevented because watering from the bottom is carried out smoothly through the gap at the contact surface between the external container and the internal container, and the roots can extend into the external container.

### BRIEF DESCRIPTION OF THE DRAWINGS

FIG. 1A is a plan view of an embodiment of a hydroponic plant culture container of the present invention, and shows a state in which the container has been filled with growing medium, FIG. 1B is a front view of the hydroponic plant culture container of the present invention, showing a state in which the container has been filled with growing medium and sown with seeds, and FIG. 1C is a side view of the hydroponic plant culture container of the present invention;

FIG. 2A is a plan view of an external container of the hydroponic plant culture container of the present invention, FIG. 2B is a front view thereof, and FIG. 2C is a side view thereof and

FIG. 3A is a plan view of an internal container of the hydroponic plant culture container of the present invention, FIG. 3B is a front view thereof, and FIG. 3C is a side view thereof.

### BEST MODE FOR CARRYING OUT THE INVENTION

Embodiments of the present invention will be described below through reference to the drawings.

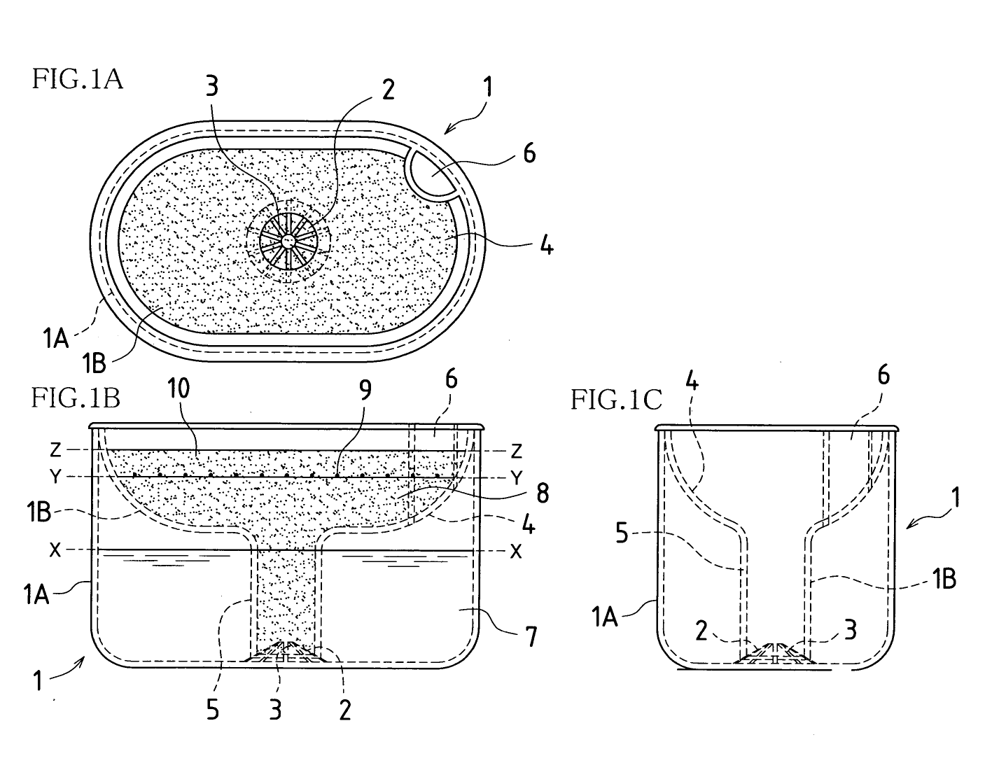

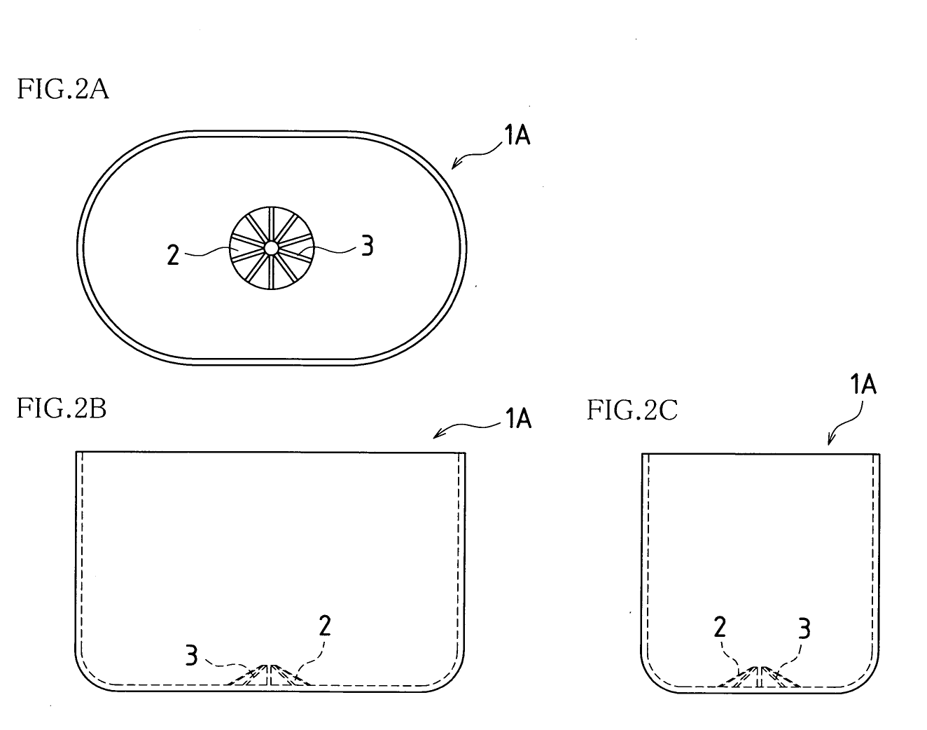

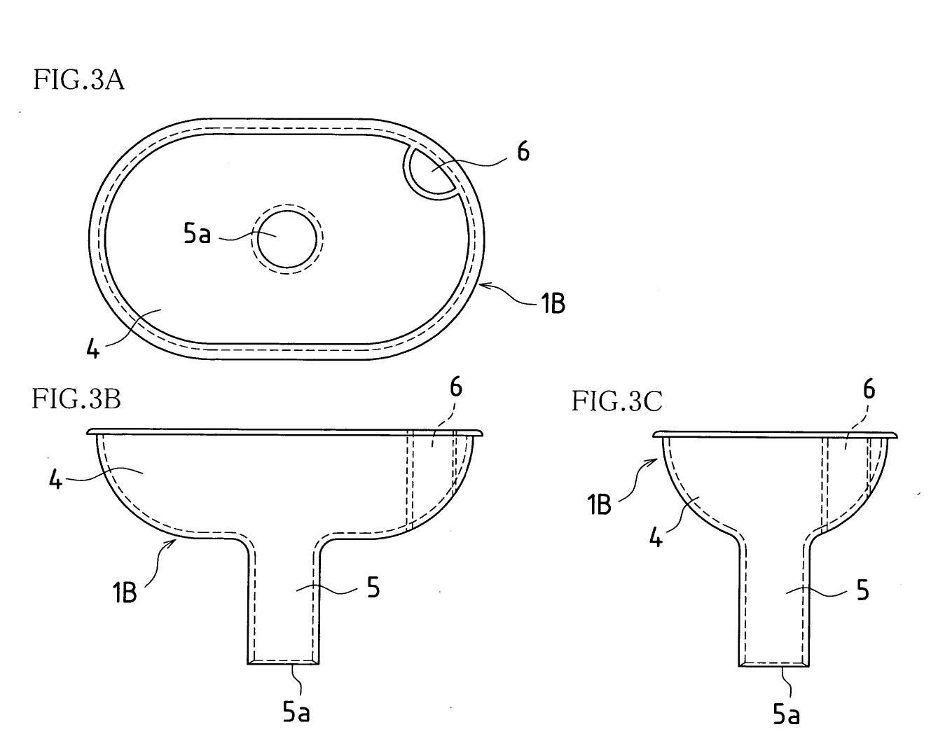

FIG. 1A is a plan view of an embodiment of a hydroponic plant culture container of the present invention, and shows a state in which the container has been filled with growing medium, FIG. 1B is a front view of this embodiment, showing a state in which the container has been filled with growing medium and sown with seeds, and FIG. 1C is a side view of this embodiment. FIG. 2A is a plan view of an external container of this embodiment, FIG. 2B is a front view thereof, and FIG. 2C is a side view thereof FIG. 3A is a plan view of the internal container of this embodiment, FIG. 3B is a front view thereof, and FIG. 3C is a side view thereof

A hydroponic plant culture container 1 of this embodiment comprises two containers: an external container 1A and an internal container 1B that is held inside this external container 1A. The internal container 1B is supported by the upper edge of the external container 1A. The external container 1A is formed from a transparent acrylic resin or other such synthetic resin, or a semitransparent milky-white resin, so that the water level can be seen. As shown in FIG. 2, the external container 1A is constituted to be able to hold water as the container 1 having an elliptical shape in plan view and a suitable depth. A peaked convex portion 2, in which a plurality of slanted grooves 3 are formed on the slope thereof from the top of the peak toward the bottom face, is provided in the central part of the bottom face of the external container 1A.

Meanwhile, the internal container 1B is similar to the external container 1A in that it is formed from a transparent acrylic resin or a semitransparent milky-white resin, and as shown in FIG. 3, has a funnel-shaped construction having an upper cup-shaped portion 4 that is formed in an elliptical shape in plan view just as is the external container 1A, and a cylindrical portion 5 that extends downward from the central part of the bottom of this cup-shaped portion 4. The inside of the internal container 1B is filled with a growing medium, and seeds are sown over the surface side of the growing medium. It is sufficient if the internal container 1B has an upper edge portion whose shape and size allow the upper edge portion to be placed on and supported by the upper edge portion of the external container 1A, and the plan view shape is not particularly restricted to being elliptical, and may instead be circular, for example.

Also, in this embodiment an example is given in which the cylindrical portion 5 and the cup-shaped portion 4 are formed integrally, but they may instead be separate, and the cylindrical portion 5 and cup-shaped portion 4 may be linkable. Also, the size and shape of the cup-shaped portion 4 and cylindrical portion 5 can be suitably selected according to the intended application. The lower end of the cylindrical portion 5 is open, forming an opening 5a. It is also favorable to provide grooves extending in the axial direction in the inner walls of this cylindrical portion 5 to make water flow and absorption more effective, as needed.

Also, a watering port 6 is provided on one side of the upper edge of the cup-shaped portion 4 of the above-mentioned funnel-shaped internal container 1B, so that, rather than watering the upper surface of the growing medium, water will flow down through the internal container 1B to beneath the cylindrical portion 5 and will flow out as needed from the lower end opening of the cylindrical portion 5 into the external container 1A, while the water held in the external container 1A will go through the cylindrical portion and water the seeds at the top from the bottom of the growing medium. A watering portion may also be provided to a side face of the external container 1A and some of the water introduced there.

The hydroponic culture container shown in FIG. 1, as discussed above, has the internal container 1B held inside the external container 1A, and the internal container 1B placed on and supported by the upper edge portion of the external container 1A. The inside of this external container 1A is filled with water 7 to approximately one-half the height thereof, the inside of the internal container 1B is filled with growing medium 8, and seeds 9 are sown over the surface of the growing medium 8 in the cup-shaped portion 4 and covered with cover soil 10.

The water fill limit level in the external container 1A, the seed sowing limit level in the internal container 1B, and the cover soil fill limit level are important factors in hydroponic culture, and of these, it is preferable for the water fill limit level (X-X) and the seed sowing limit level (Y-Y) to be at least 2.4 cm apart in order to prevent over-watering and to achieve complete germination. It is also effective for the seed sowing limit level (Y-Y) and the cover soil fill limit level (Z-Z) to be about 1 cm apart. Therefore, for the above factors to be satisfied as fully as possible, the slanted grooves 3 are formed radiating out at the contact face between the external container 1A and the internal container 1B when on the bottom face the lower end of the cylindrical portion 5 of the internal container 1B is mated to the peaked convex portion in the center of the bottom face of the external container 1A, so that absorptivity from the bottom part of the growing medium will be increased and the tips of the roots will not become pent up in the growing medium. The result is that the watering time can be adjusted, watering from the bottom is smoother, and the roots can escape into the external container 1A, preventing a decrease in absorptivity and poor growth.

The features of the above embodiment of hydroponic culture according to the present invention will now be summarized. The first is that watering from the surface of the growing medium is eliminated, and instead the seeds are watered from the bottom of the growing medium through the opening 5a at the lower end of the cylindrical portion of the internal container 1B. This results in higher water absorptivity, and furthermore because the growing medium is one that is lightweight and soft, exposure, clumping, and so forth of the seeds due to water pressure cannot be avoided if the watering is performed from the top of the growing medium, but these problems are not encountered with the present invention, nor is there uneven germination, and little mold develops.

The second feature is that the radial grooves 3 are provided to the peaked convex portion 2 in the center part of the bottom face of the external container 1A. The result is that the internal container will not float up and allow the growing medium to leak into the external container, and the watering time can also be adjusted. Furthermore, if root growth should fill up the internal container, it can result in poor growth and a decrease in absorptivity, but providing the above-mentioned grooves makes watering from the bottom smoother, and allows the roots to go through the grooves into the external container 1A and thereby preventing poor growth or a decrease in absorptivity.

The third feature is the setting of the water fill limit level, the seed sowing limit level, and the cover soil fill limit level. The spacing between the water fill limit level and the seed sowing limit level is the most important factor of all, and setting it to at least 2.4 cm will prevent over-watering, and the fact that complete germination occurs can be utilized to determine the watering volume so that hydroponic culture will be possible with fewer waterings in typical household culture.

### Working Examples

Test examples of the present invention will now be given.

Test 1

The water level under the seeds was tested as follows. The results are given in Table 1.

Growing medium: fine vermiculite particles, volume of 150 cc

Seeds: oats, volume of 10 cc (120 seeds)

Cover soil: 1 cm above (from seed location)

Cultivation time: 11 months

TABLE 1

| Water- | | Water level | | Remaining | Germi- |
|---|---|---|---|---|---|
| ing | Water level | after | Water level | amount of | nation |
| amount | under seeds | completion | difference | water | rate |
| 500 cc | 1.2 cm under | 2.7 cm under | 1.5 cm | 320 cc | 20% |
| 475 cc | 1.6 cm under | 3.1 cm under | 1.5 cm | 290 cc | 30% |
| 450 cc | 2.0 cm under | 3.5 cm under | 1.5 cm | 260 cc | 40% |
| 425 cc | 2.4 cm under | 4.2 cm under | 1.8 cm | 180 cc | 95% |
| 400 cc | 2.8 cm under | 4.6 cm under | 1.8 cm | 150 cc | 95% |
| 375 cc | 3.2 cm under | 5.1 cm under | 1.9 cm | 110 cc | 95% |
| 350 cc | 3.6 cm under | 5.6 cm under | 3.0 cm | 70 cc | 95% |

The results of Test 1 above show that there is a pronounced change in the germination rate between levels of 2.0 and 2.4 cm under the seeds. Meanwhile, it can be seen that the remaining amount of water is inversely proportional to the germination rate, to how good the growth is, and to how much water is consumed by growth.

Test 2

A test of watering from above the growing medium was conducted as follows. The results are given in Table 2.

Growing medium: fine vermiculite particles, volume of 150 cc

Seeds: oats, volume of 10 cc (120 seeds)

Cover soil: 1 cm above (from seed location)

Watering amount: 350 cc

Cultivation time: 11 months

TABLE 2

| | | Side watering | Above-medium | Above-medium water |
|---|---|---|---|---|
| | | container, with | water container, | container, without |
| | | grooves | with grooves | grooves |
| 1 | Watering time | 7 seconds | 60 seconds | 95 seconds |
| 2 | Water level under seeds | 3.6 cm under | 3.8 cm under | 4.1 cm under |
| 3 | Germination rate | 95% | 75% | 50% |
| 4 | Seed exposure rate | 0.0% | 20% | 40% |
| 5 | Rise of growing | 0 cm | 1.0 cm | 2.0 cm |
| | medium | | | |
| 6 | Surface of medium | flat | bumpy | some 1.8 cm |
| | | | | depressions |
| 7 | Molding | no | yes | yes |
| 8 | Turbidity of water in | no | yes | yes |
| | container | | | |

The results of the above Test 2 revealed various things, as in 1 to 8 below.

1. The difference in watering times occurs because when the watering is performed from above the growing medium, the medium rises and protrudes to the outside, so the watering takes longer.

2. The difference in the water levels under the seeds occurs because it takes longer to water from above the growing medium, so the seeds absorb more water.

3. The germination rate is worse if either the growing medium or the seeds absorb too much water.

4. The seeds always appear on the surface when watered from above the growing medium. Also, the longer is the watering time, the more the seeds float up, so the higher is the seed exposure rate.

5. When the growing medium is watered from above, it at first rises about twice as much as the above test results, and then drops to half upon completion of watering.

6. Because the growing medium that was used has a surface with high absorptivity, and is lightweight and soft, the growing medium always becomes bumpy due to water pressure when watered from above. When there are no grooves, depressions appear 20 seconds after completion of watering, and this is because the water that has collected in the internal container flows all at once into the external container.

7. Molding occurs if the seeds appear on the surface of the growing medium. That leads to a conclusion that when the growing medium is watered from above, the seeds will always appear on the surface of the growing medium.

8. As to the turbidity of the water in the container, when the growing medium is watered from above, the water turns dark brown and has no clarity at all. The water clears up in about 5 days, but the transparency is still low.

In an embodiment of the present invention, there is little seed rot, withering, wilting, molding, or root rot, and since fewer waterings are needed, grasses eaten by dogs and cats, and sprout vegetables can be cultivated in the home in a short period of time.

The present invention was mainly described for the cultivation of cat grass and sprout vegetables (such as daikon radish sprouts and broccoli), but is not limited to this, and can also be suitably applied to the cultivation of cibols or decorative plants (such as clover and milk vetch), for example. In this case, although cat grass and sprout vegetables can be more or less cultivated in about 15 to 20 days, the cultivation of cibols and so forth can take about 60 days. In this cultivation, it will also be necessary to add fertilizer (a liquid or water-soluble fertilizer), but fertilizer can be easily added through a top watering port.

The present invention can be worked in various configurations without departing from the spirit or main features thereof. Therefore, the above embodiments are in all respects nothing more than mere examples, and should not be interpreted as limiting in nature. The scope of the present invention is as indicated by the Claims, and is not restricted whatsoever to the text of this Specification. Furthermore, all modifications and variations belonging to a scope equivalent to the Claims fall within the scope of the present invention.

What is claimed is:

1. A method for hydroponic plant culture, using a hydroponic plant culture container comprising an external container that holds water, and an internal container that is held inside the external container, is placed on and supported by the upper edge portion of the external container, and is filled with a growing medium with seeds sown on the upper surface side thereof,
wherein these containers both are formed from a transparent or semitransparent synthetic resin, and the internal container is a funnel-shaped container including a cup-shaped portion and a cylindrical portion extending downward from a central part of the bottom of the cup-shaped portion,
the method comprising:
filling the internal container with a growing medium in a state in which a lower end of the cylindrical portion of the internal container is substantially in contact with a bottom face of the external container with a gap interposed therebetween,
sowing seeds on the surface side of the growing medium, and
supplying water through a watering port formed on one side of the cup-shaped portion of the internal container, whereby water is supplied into the external container through a gap at the lower end of the cylindrical portion, and the water that has been supplied to and held in the external container is used to water the seeds sown in the internal container through the gap.

2. The method for hydroponic plant culture according to claim 1, wherein an upper limit to the water level inside the external container is at least 2.4 cm away from the location of the seeds sown in the internal container.

3. A hydroponic plant culture container, comprising:
an external container that holds water, and
an internal container that is held inside the external container, is placed on and supported by the upper edge portion of the external container, and is filled with a growing medium with seeds sown on the upper surface side thereof,
wherein these containers are both formed from a transparent or semitransparent synthetic resin,
the internal container is a funnel-shaped container including a cup-shaped portion and a cylindrical portion extending downward from a central part of the bottom of the cup-shaped portion,
a convex portion that mates with an opening in a lower end of the cylindrical portion is formed in a central part of a bottom face of the external container, a plurality of slanted grooves extending radially toward the bottom face being formed in this convex portion, and
a watering port is provided on one side of the upper edge of the cup-shaped portion,
wherein water that has come through the watering port is supplied to the external container through the internal container and through the slanted grooves, whereas the water that has been supplied to and held in the external container is supplied to the growing medium in the internal container through the slanted grooves, and roots of plants growing in the medium are able to spread out into the external container through the opening at the lower end of the cylindrical portion.
